(19) United States
(12) Patent Application Publication
(10) Pub. No.: US 2014/0362194 A1
(43) Pub. Date: Dec. 11, 2014

(54) IMAGE PROCESSING DEVICE, IMAGE PROCESSING METHOD, AND STEREOSCOPIC IMAGE DISPLAY DEVICE

(71) Applicant: KABUSHIKI KAISHA TOSHIBA, Tokyo (JP)

(72) Inventors: Ryusuke HIRAI, Tokyo (JP); Kenichi SHIMOYAMA, Tokyo (JP); Takeshi MITA, Yokohama-shi (JP)

(73) Assignee: KABUSHIKI KAISHA TOSHIBA, Tokyo (JP)

(21) Appl. No.: 14/172,114

(22) Filed: Feb. 4, 2014

(30) Foreign Application Priority Data
Jun. 11, 2013 (JP) 2013-122597

(51) Int. Cl. H04N 13/04

(52) U.S. Cl. CPC H04N 13/0468
USPC 348/51

(57) ABSTRACT

According to an embodiment, an image processing device includes a first detector, a calculator, and a determiner. The first detector is configured to detect a position of a viewer. The calculator is configured to calculate a position variation probability that indicates a probability of the viewer making a movement, based on positions detected at different times. The determiner is configured to determine a visible area within which stereoscopic images to be displayed on a display are visible, based on the position variation probability.

### CROSS-REFERENCE TO RELATED APPLICATION

This application is based upon and claims the benefit of priority from Japanese Patent Application No. 2013-122597, filed on Jun. 11, 2013; the entire contents of which are incorporated herein by reference.

### FIELD

Embodiments described herein relate generally to an image processing device, an image processing method, and a stereoscopic image display device.

### BACKGROUND

Typically, a technology is known in which a visible area, which enables viewing of stereoscopic images that are being displayed on a 3D display, is controlled in tune with the positions of viewers who are viewing the 3D display.

For example, a technology is known for figuring out the positions of viewers by means of a face detection technology and forming the visible area in such a way that the maximum number of viewers as included in the visible area. In this technology, in a situation in which a plurality of viewers is viewing stereoscopic images; every time any of the viewers moves around, the visible area is also moved (changed).

However, in this technology, in case a change in the position of a viewer that occurs due to a detection error is regarded as a movement of that viewer, then the control for changing the visible area is performed even if that viewer is motionless in reality. As a result, an appropriate visible area control cannot be performed.

### BRIEF DESCRIPTION OF THE DRAWINGS

FIG. 1 is a diagrammatic illustration of a stereoscopic image display device according to a first embodiment;

FIG. 2 is a diagram illustrating a configuration example of a display according to the first embodiment;

FIG. 3 is a schematic diagram illustrating a situation in which a viewer is viewing the display according to the first embodiment;

FIG. 4 is a block diagram illustrating an exemplary functional configuration of an image processor according to the first embodiment;

FIG. 5 is a diagram illustrating a pinhole camera model according to the first embodiment;

FIGS. 6 to 8 are diagrams for explaining examples of controlling a visible area according to the first embodiment;

FIG. 9 is a flowchart for explaining an example of operations performed by a determiner according to the first embodiment;

FIG. 10 is a flowchart for explaining an example of operations performed by the image processor according to the first embodiment;

FIG. 11 is a block diagram illustrating an exemplary functional configuration of an image processor according to a second embodiment; and

FIG. 12 is a flowchart for explaining an example of operations performed in the image processor according to the second embodiment.

### DETAILED DESCRIPTION

According to an embodiment, an image processing device includes a first detector, a calculator, and a determiner. The first detector is configured to detect a position of a viewer. The calculator is configured to calculate a position variation probability that indicates a probability of the viewer making a movement, based on positions of the viewer detected at different times. The determiner is configured to determine a visible area within which stereoscopic images to be displayed on a display are visible, based on the position variation probability.

Exemplary embodiments of an image processing device, an image processing method, and a stereoscopic image display device according to the invention are described below in detail with reference to the accompanying drawings.

### First Embodiment

An image processing device according to a first embodiment can be used in a stereoscopic image display device such as a television (TV), a personal computer (PC), a smartphone, or a digital photo frame that enables a viewer to view stereoscopic images with the unaided eye. Herein, a stereoscopic image points to an image that includes a plurality of parallax images having mutually different parallaxes. Meanwhile, in the embodiments, an image can either be a still image or be a dynamic picture image.

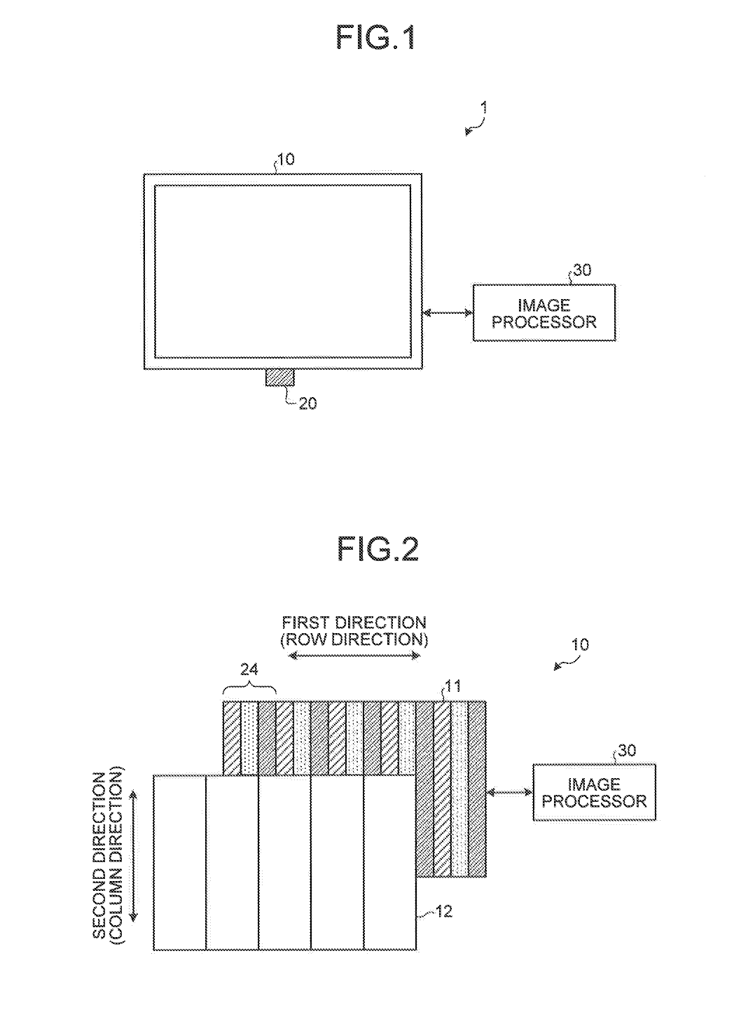

FIG. 1 is a diagrammatic illustration of a stereoscopic image display device 1 according to the embodiment. As illustrated in FIG. 1, the stereoscopic image display device 1 includes a display 10, a sensor 20, and an image processor 30.

FIG. 2 is a diagram illustrating a configuration example of the display 10. As illustrated in FIG. 2, the display 10 includes a display element 11 and an aperture controller 12. When a viewer views the display element 11 via the aperture controller 12, he or she becomes able to view the stereoscopic image being displayed on the display 10.

The display element 11 displays thereon the parallax images that are used in displaying a stereoscopic image. As far as the display element 11 s concerned, it is possible to use a direct-view-type two-dimensional display such as an organic electro luminescence (organic EL), a liquid crystal display (LCD), a plasma display panel (PDP), or a projection-type display. The display element 11 can have a known configuration in which, for example, a plurality of sub-pixels having red (R), green (G), and blue (B) colors is arranged in a matrix-like manner in a first direction (for example, the row direction with reference to FIG. 2) and a second direction (for example, the column direction with reference to FIG. 2). In the example illustrated in FIG. 2, a single pixel is made of RGB sub-pixels arranged in the first direction. Moreover, an image that is displayed on a group of pixels, which are adjacent pixels equal in number to the number of parallaxes and which are arranged in the first direction, is called an element image 24. Meanwhile, any other known arrangement of sub-pixels can also be adopted in the display element 11. Moreover, the sub-pixels are not limited to the three colors of red (R), green (G), and blue (B). Alternatively, for example, the sub-pixels can also have four colors.

The aperture controller 12 shoots the light beams, which are anteriorly emitted from the display element 11, toward a predetermined direction via apertures (hereinafter, the apertures having such a function are called optical apertures). Examples of the aperture controller 12 are a lenticular sheet, a parallax barrier, and a liquid crystalline GRIN lens. The optical apertures are arranged corresponding to the element images of the display element 11.

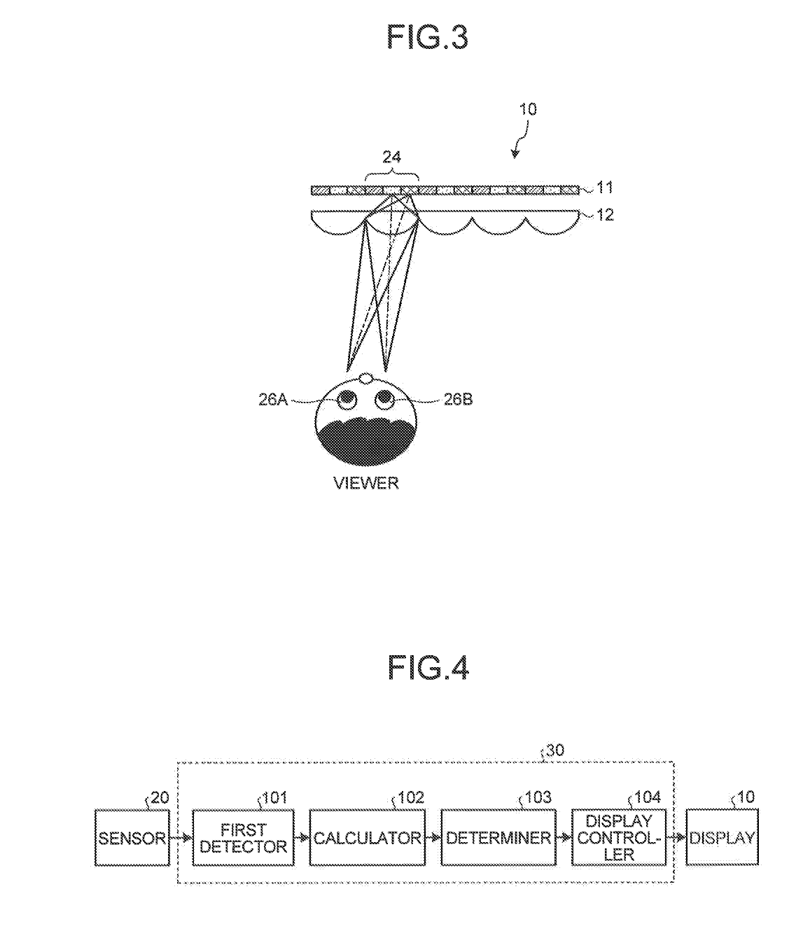

FIG. 3 is a schematic diagram illustrating a situation in which a viewer is viewing the display 10. When a plurality of element images is displayed on the display element 11, a parallax image group corresponding to a plurality of parallax directions gets displayed (i.e., a multiple parallax image gets displayed) on the display element 11. The light beams coming out from this multiple parallax image pass through the optical apertures. Then, the pixels included in the element images and viewed by the user with a left eye 26A are different than the pixels included in the element images and viewed by the user with a right eye 26B. In this way, when images having different parallaxes are displayed with respect to the left eye 26A and the right eye 26B of the viewer, it becomes possible for the viewer to view stereoscopic images. Moreover, the range within which the viewer is able to view stereoscopic images is called the visible area.

In the first embodiment, the aperture controller 12 is disposed in such a way that the extending direction of the optical apertures thereof is consistent with the second direction (the column direction) of the display element 11. However, that is not the only possible case. Alternatively, for example, the configuration can be such that the aperture controller 12 is disposed in such a way that the extending direction of the optical apertures thereof has a predetermined tilt with respect to the second direction (the column direction) of the display element 11 (i.e., the configuration of a slanted lens).

Returning to the explanation with reference to FIG. 1, the sensor 20 is used in detecting the position (in this example, the three-dimensional position) of each viewer who is viewing stereoscopic images. In this example, the sensor 20 is configured with a monocular camera, and is sometimes referred to as a camera 20 in the following explanation. The camera 20 captures (takes images of) a predetermined area in the real space. In the following explanation, an image taken by the camera 20 is sometimes called a captured image; and a target object such as the face of a person that appears in a captured image is sometimes called an object. Herein, the installation position of the camera 20 or the number of cameras 20 to be installed can be set in an arbitrary manner. The camera takes images at a predetermined interval (for example, at 1/30 seconds). Every time the camera 20 takes an image, the captured image that is obtained is sent to the image processor 30. Meanwhile, the frame rate of the camera 20 is not limited to 1/30 seconds (i.e., 30 frames per second (fps)), and can be set in an arbitrary manner.

Given below is the explanation of the image processor 30. Prior to giving the details of the image processor 30, an overview of the functions of the image processor 30 is given. The image processor 30 detects and tracks the face of a viewer who is appearing in a captured image, and obtains the three-dimensional position of that viewer from the size of the face in the captured image. At that time, the image processor 30 obtains a position variation probability, which indicates the probability of the viewer making a movement, from the degree of change between the past position and the current position (i.e., the temporal change in the position of the viewer); and determines the visible area by referring to the position variation probability. Then, the image processor 30 controls the display 10 in such a way that the determined visible area gets formed. Meanwhile, the image processor 30 corresponds to an “image processing device” mentioned in claims.

Explained below are the details of the image processor 30. FIG. 4 is a block diagram illustrating an exemplary functional configuration of the image processor 30. As illustrated in FIG. 4, the image processor 30 includes a first detector 101, a calculator 102, a determiner 103, and a display controller 104.

The first detector 101 detects the positions of viewers. Herein, only a single viewer may be present, or a plurality of viewers may be present. In the first embodiment, every time a captured image is input from the camera 20, the first detector 101 detects the face of each viewer who is appearing in that captured image and detects the position of that viewer from the size of the corresponding face in the captured image. More particularly, the operations are performed in the following manner.

The first detector 101 scans a search window of a plurality of predetermined sizes over the captured image obtained by the camera 20; evaluates the degree of similarity between a prepared pattern of an image of the object and the pattern of the image within the search window; and accordingly determines whether or not the image within the search window represents the object. For example, when the target object is the face of a human being, it is possible to implement the search method disclosed in Paul Viola and Michael Jones, “Rapid Object Detection using a Boosted Cascade of Simple Features”, IEEE conf. on Computer Vision and Pattern Recognition, CVPR 2001. In that search method, a number of rectangular features are obtained with respect to the image within the search window, and whether or not the image represents a face is determined using a strong classifier in which weak classifiers corresponding to the rectangular features are connected in series.

In the case of implementing the abovementioned search method in the image processor 30, the configuration can be such that a pattern classifier (not illustrated) is disposed in each functional component (described later in detail) involved in the search method. A pattern classifier has a cascade structure in which a plurality of weak classifiers is connected in series, and points to an AdaBoost cascade classifier disclosed in Non-patent literature 1.

More particularly, in a pattern classifier, the weak classifier at each level of the cascade determines whether the object in a captured image that has been input is a face or a non-face, and carries forward only the image determined to include a face to the weak classifier at the next level. Then, the image that passes through the last weak classifier is determined to be the eventual face image.

The strong classifier constituting each level of the cascade has a plurality of weak classifiers connected in series. Each such weak classifier performs evaluation by referring to the rectangular features obtained with respect to the image within the search window.

Herein, if “x” represents the two-dimensional coordinate position vector in an image being searched, then the output of a particular weak classifier n regarding the position vector x is expressed using Expression (1) given below.

$${h}_{n} ( x ) = \{ \begin{matrix}1 & if {p}_{n} {f}_{n} ( x ) < {p}_{n} {θ}_{n} \\ - 1 & otherwise\end{matrix} \qquad ( 1 )$$

In Expression (1), hₙ(x) represents the output of the weak classifier n; and fₙ(x) represents the judging function of the weak classifier n. Moreover, in Expression (1), pn represents either the number “1” or the number “−1” used in determining the inequality sign; and θₙ represents a predetermined threshold value with respect to each weak classifier n. For example, θₙ is set during the learning at the time of creating classifiers.

Regarding a strong classifier having N number of weak classifiers connected in series, the output is expressed using Expression (2) given below.

$$H ( x ) = {\sum }_{n = 1}^{N} {α}_{n} {h}_{n} ( x ) \qquad ( 2 )$$

In Expression (2), H(x) represents the output of a strong classifier that has N number of weak classifiers connected in series. Moreover, in Expression (2), αₙ represents the weight of a predetermined weak classifier n; and hₙ represents the output of the weak classifier n expressed in Expression (1). For example, αₙ is set during the learning at the time of creating classifiers.

In order to calculate likelihood l(x) indicating the likelihood that the image which has passed through the pattern classifier represents a face, Expression (3) given below is used.

$$l ( x ) = \frac{1}{1 + exp ( - aH ( x ) )} \qquad ( 3 )$$

In Expression (3), “a” represents a constant number indicating the weight generated during the learning at the time of creating classifiers. Moreover, in Expression (3), H(x) represents the output of the strong classifier.

Meanwhile, the target object is not necessarily captured from only a certain direction. For example, it is also possible to think of a case when the target object is captured from a transverse direction or an oblique direction. In such a case, the image processor 30 is configured to include a pattern classifier for the purpose of detecting the profile. Moreover, in the image processor 30, each functional component involved in implementing the search method is assumed to be configured to include a pattern classifier that corresponds to each of one or more orientations of the target object.

Meanwhile, it is also possible to use a stereo camera as the sensor 20. In that case, the first detector 101 can perform face detection from two images that are captured using the stereo camera; and can obtain the three-dimensional position of a viewer from the parallax at the detected position by means of triangulation.

Alternatively, the sensor 20 can be a distance sensor in which wavelengths on the outside of the visible light range (for example, wavelengths of infrared light) are used. For example, the first detector 101 can obtain the three-dimensional position of the viewer from the measurement result of the distance sensor that is capable of measuring the distance of the image capturing range of the camera 20. Meanwhile, the configuration can be such that the sensor 20 is disposed inside the first detector 101.

Regarding a viewer who has been detected once, the first detector 101 tracks that viewer from the subsequent timing so as to be able to determine whether it is the same viewer. As far as the tracking method is concerned, for example, every time a captured image is input from the camera 20, face detection is performed and it can be determined that the face detected at the closest position to the face position of the previous timing is of the same viewer. Alternatively, a method can be implemented in which the face detection is performed with respect to only the neighborhood of the position of the face detected in the past. Herein, it is common practice to set the neighborhood using, for example, a particle filter in which a hypothesis of the face position at the current timing is set in the vicinity of the previously-detected position.

Given below is the explanation of a method for calculating the three-dimensional position of a viewer from the size of the face detected in the manner described above. Firstly, using a pinhole camera model, the explanation is given about the relationship between the actual size of a detected face, the width of the face in the captured image, and the distance from the camera 20 to the face. In this example, the position of the camera 20 is set to be at an origin O in the real space. Moreover, the horizontal direction passing through the origin O is assumed to be the X-axis. Furthermore, the direction that passes through the origin O and that has the imaging direction of the camera 20 on the positive side is assumed to the Z-axis. Furthermore, the direction that is vertical with respect to the XZ plane formed by the X-axis and the Z-axis, that passes through the origin O, and that has the antigravity direction of the camera 20 on the positive side is assumed to be the Y-axis. In the first embodiment, the coordinate system defined by the X-axis, the Z-axis, and the Y-axis is explained as the three-dimensional coordinate system in the real space. However, the method of setting the coordinates in the real space is not limited to this case.

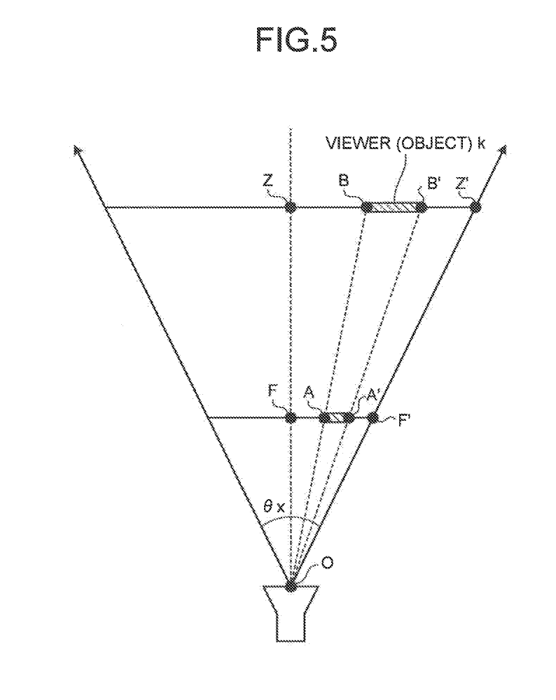

FIG. 5 is a diagram illustrating a geometric relation between the camera 20 and a viewer k in the XZ place formed by the X-axis and the Z-axis. The camera 20 is placed at the origin O, and it is assumed that θx represents the angle of view of the camera 20 in the X-axis direction, F represents the focal position of the captured image in the Z-axis direction, and Z represents the position of the viewer k in the Z-axis direction. Moreover, a width wk of a rectangular area of the viewer k included in the search window in the captured image represents the length of a side AA′ illustrated in FIG. 5; an actual size Wk of the viewer k represents the length of a side BB′ illustrated in FIG. 5; and the length of a side OZ represents the distance from the camera 20 to the viewer k. When θx represents the angle of view of the camera 20 and Iw represents the horizontal resolution of the captured image, a distance OF from the camera 20 to the focal position F can be represented using Expression (4) given below. Herein, OF is a constant number that is fixed according to the specifications of the camera 20.

$$OF = \frac{Iw}{2 tan ( \frac{{θ}_{x}}{2} )} \qquad ( 4 )$$

With reference to FIG. 4, regarding AA′, BB′, OF, and OZ; the relationship of AA′:BB′=OF:OZ is satisfied due to the scaling relationship. Thus, a distance Zk from the camera 20 to the viewer k can be represented using Expression (5) given below.

$${Z}_{k} = \frac{OF}{{w}_{k}} {W}_{k} \qquad ( 5 )$$

Moreover, BZ can be obtained using the relationship of AA′:BB′=OF:OZ. As a result, it becomes possible to estimate the X-coordinate of the viewer k in the three-dimensional coordinate system. Then, regarding the YZ plane too, the Y-coordinate of the viewer k in the three-dimensional coordinate system can be estimated in an identical manner. In this way, the first detector 101 can detect the three-dimensional position of the viewer k.

Returning to the explanation with reference to FIG. 4, the calculator 102 calculates the position variation probability, which indicates the probability of the viewer making a movement, based on the positions of the viewer detected at different times. More particularly, the calculator 102 calculates the position variation probability based on the temporal change in the position of the viewer detected by the first detector 101. Herein, the position variation probability is designed in such a way that, the position variation probability lowers as the voluntariness in the movement made by the viewer increases, lower becomes the position variation probability. In other words, in a situation in which the viewer is not moving voluntarily, the position variation probability is designed to increase. Thus, the value indicated by the position variation probability decreases as the possibility of the viewer making a movement increases.

The calculator 102 calculates the position variation probability using a probability distribution which indicates that, the position variation probability becomes greater as the temporal change in the position of the viewer becomes smaller. More particularly, the explanation is as given below. Herein, the three-dimensional position of a viewer A at a timing t is expressed as (X_{A}(t), Y_{A}(t), Z_{A}(t)). As described above, the origin of the three-dimensional coordinate system is assumed to be the position of the camera 20. Then, a position variation probability P_{A}(t) of the viewer A at the timing t can be obtained using Expression (6) given below.

$${P}_{A} ( t ) = 1 - \frac{1}{{( \sqrt{2 π} )}^{3} \sqrt{\vert \sum \vert}} exp ( - \frac{1}{2} {( {V}_{A} ( t - 1 ) - {V}_{A} ( t ) )}^{T} {\sum }^{- 1} ( {V}_{A} ( t - 1 ) - {V}_{A} ( t ) ) ) \qquad ( 6 )$$

In Expression (6), Σ represents a 3×3 covariance matrix that is obtained from statistical data of the temporal difference in the three-dimensional positions detected by the first detector 101. Moreover, in Expression (6), V_{A}(t) represents a vector expressing the three-dimensional position of the viewer A at the timing t. That is, v_{A}(t)=[X_{A}(t), Y_{A}(t), Z_{A}(t)] is satisfied. Furthermore, |Σ| represents the determinant of the covariance matrix Σ. When the statistical data of the temporal difference in the three-dimensional positions is not provided, the covariance matrix Σ can be set as illustrated in Expression (7) given below.

Σ=diag(σₓ²,σ_{y}²,σ_{z}²) (7)

Thus, the output of the temporal difference in the positions in the X-axis direction, the output of the temporal difference in the positions in the Y-axis direction, and the output of the temporal difference in the positions in the Z-axis direction can be independent of each other. In Expression (7), σx represents the standard deviation in the temporal difference in the positions in the X-axis direction, σy represents the standard deviation in the temporal difference in the positions in the Y-axis direction, and σz represents the standard deviation in the temporal difference in the positions in the Z-axis direction. Herein, σx, σy, and σz can be set to be, for example, equal to half of the average size of the human head region. Alternatively, σx, σy, and σz can be set according to the frame rate of the camera 20. For example, σx set at a particular frame rate F can be used to obtain σx at the current frame rate F′ using (F′/F)×σx. Regarding σy and σz too, the setting can be done in an identical manner.

As can be understood from Expression (6) given above, closer the three-dimensional position v_{A}(t) of the viewer A at the timing t to a three-dimensional position v_{A}(t−1) of the viewer A at a timing t−1, that is, smaller the temporal change in the three-dimensional position of the viewer A detected by the first detector 101; greater is the value indicated by the position variation probability P_{A}(t). That is, Expression (6) can be regarded to represent a probability distribution which indicates that, smaller the temporal change in the position of the viewer A, greater becomes the position variation probability.

Herein, as is the case in the first embodiment, when the three-dimensional position of a viewer is detected by detecting his or her face appearing in the capturing image; farther the position of the viewer from the camera 20, greater becomes the measuring error (detection error). That is because the face of a viewer positioned at a distant position from the camera 20 appears smaller in the captured image as compared to the face of a viewer positioned close to the camera 20. That makes it difficult for the first detector 101 to output an accurate size of the face. Moreover, in the case of converting the size of the face detected by the first detector 101 into distance; as illustrated in Expression (5) given above, a size (wₖ) of the face appearing in the captured image bears an inverse relation to distance (OF) from the camera 20 to the viewer. Hence, greater the distance from the camera 20 to the viewer, greater is the value obtained by converting the error in the face size detected by the first detector 101 into distance. Thus, greater the distance from the camera 20 to the viewer, greater becomes the detection error of the face size and greater becomes the amount of variation (v_{A}(t−1)−(v_{A}(t)) in the position of the viewer occurring due to the detection error. Hence, the position variation probability P_{A}(t) that is calculated accordingly becomes smaller (see Expression (6)). For that reason, regardless of the fact that the viewer is motionless in reality, it is likely to be regarded that the viewer has moved.

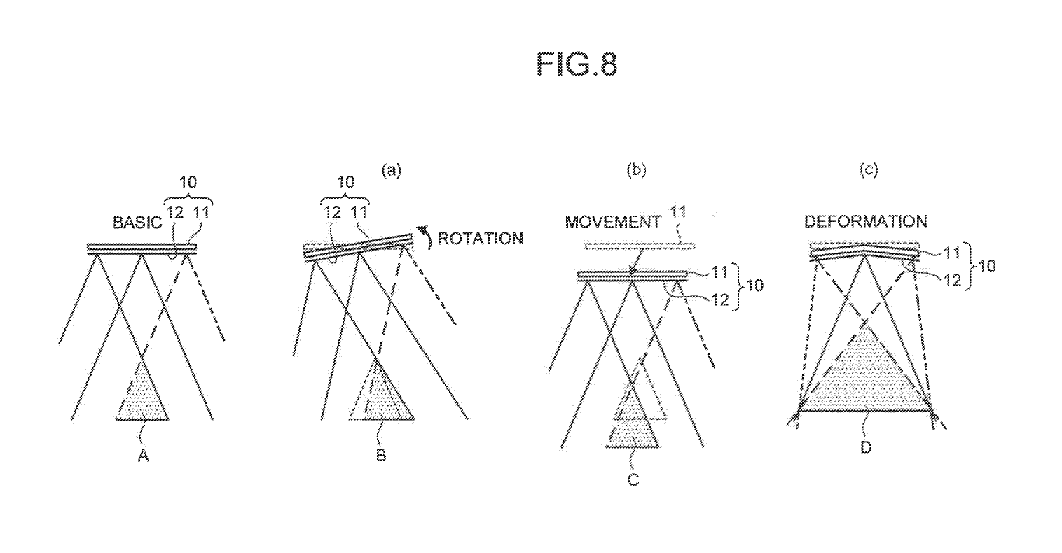

Then, in the first embodiment, the calculator 102 sets the probability distribution in such a way that, the range of the probability distribution increases as the distance increases from the sensor 20 to the viewer. Consider a case in which it is ensured that, the range of the probability distribution increases as the distance increases from the sensor 20 to the viewer. In that case, even if there is a large amount of variation (v_{A}(t−1)−(v_{A}(t)) in the position of the viewer occurring due to the detection error, it becomes possible to prevent a decrease in the position variation probability P_{A}(t) that is calculated accordingly. More particularly, as illustrated in FIG. 8 given below; σx, σy, and σz can be set using a function Z_{A}(t) that is related to the distance of the viewer A from the camera 20 at the timing t.

σₓ²=αZ_{A}(t), σ_{y}²=βZ_{A}(t), σ_{y}²=γZ_{A}(t) (8)

In Expression (8); since α, β, and γ are dependent on the performance of the face detector, they can also be obtained from the statistical data of the position of the viewer detected by the first detector 101. Alternatively, for example, the setting of α=0.05, β=0.05, and γ=0.1 is done so as to have the Gaussian distribution that is anisotropic in nature.

As described above, in the first embodiment, the range of the probability distribution increases as the distance increases from the sensor 20 to the viewer. However, that is not the only possible case. Alternatively, for example, the configuration can be such that, regardless of the distance from the sensor 20 to the viewer, the range of the probability distribution is set to a constant value.

Meanwhile, in the first embodiment, since the position of a viewer is detected using a face detector, the detection is often affected by the noise in the captured image. Hence, in order to ensure stable operations, it is also possible to prevent a sudden variation in the position of the viewer using a first order lag given in Expression (9) below. Other than that, for example, the detected position of the viewer can be corrected using a Kalman filter.

V_{A}(t)←αV_{A}(t)+(1−α)V_{A}(t−1) (9)

Moreover, for example, based on the position variation probability of a viewer calculated based on the positions of the viewer detected during a predetermined time period in the past, the calculator 102 can calculate the current position variation probability of that viewer. The predetermined time period is expressed as the product of a detection interval, which indicates the interval at which the first detector 101 performs detection (in this example, the frame rate of the camera 20), and an integer N that is set to a value which increases as the detection interval decreases. For example, when the camera 20 has the frame rate of 10 fps ( 1/10 seconds), the integer N is set to 10. Similarly, when the camera 20 has the frame rate of 30 fps, the integer N is set to 30. As a result, the time length of the predetermined time period, which is expressed as the product of the detection interval (the frame rate of the camera 20) and the integer N, is maintained at a constant value.

In this case, the calculator 102 can make use of Expression (10) given below to calculate the position variation probability P_{A}(t) of the viewer A at the timing t.

$${P}_{A} ( t ) = {\prod }_{i = 0}^{N} {P}_{A} ( t - i ) \qquad ( 10 )$$

Alternatively, the calculator 102 can make use of Expression (11) given below to calculate the position variation probability P_{A}(t) of the viewer A at the timing t.

$${P}_{A} ( t ) = \sqrt[N]{{\prod }_{i = 0}^{N} {P}_{A} ( t - i )} \qquad ( 11 )$$

Meanwhile, regarding a new viewer for whom the position variation probability till the previous timing t−1 is not obtained, the position variation probability till the previous timing t−1 can be set to 1.

Given below is the explanation of the determiner 103 illustrated in FIG. 4. Herein, based on the position variation probability calculated by the calculator 102, the determiner 103 determines the visible area within which stereoscopic images to be displayed on the display 10 are visible. More particularly, when the position variation probability calculated by the calculator 102 is smaller than a threshold value, the determiner 103 determines to change the visible area. Then, if there is only a single viewer for which the first detector 101 has detected the three-dimensional position, the determiner 103 determines the visible area in such a way that the viewer is included in the visible area. On the other hand, when a plurality of viewers is present, the determiner 103 determines the visible area in such a way that the sum of the position variation probability of each viewer present within the visible area is the largest. The details are explained below.

Prior to giving the explanation of a visible area determination method implemented by the determiner 103, the explanation is given about the method of controlling the setting position or the setting range of the visible area. The position of the visible area is fixed according to a combination of display parameters of the display 10. Examples of the display parameters include the shift in display images, the distance (the clearance gap) between the display element 11 and the aperture controller 12, the pitch of the pixels, the rotation of the display 10, the deformation of the display 10, and the movement of the display 10.

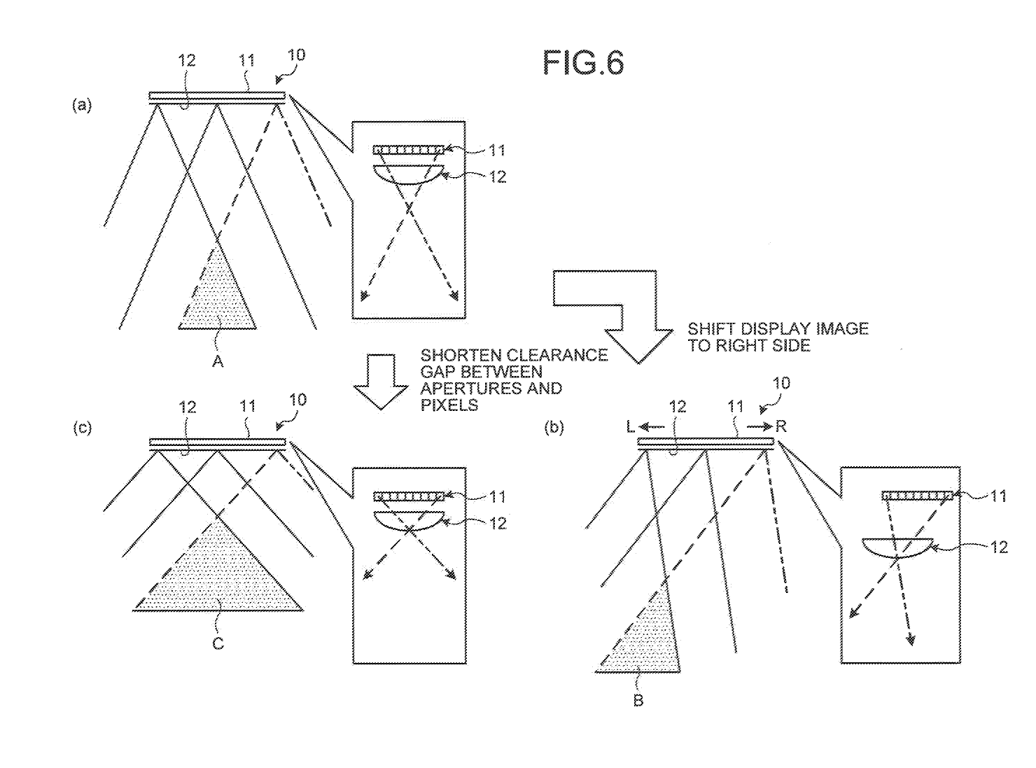

FIGS. 6 to 8 are diagrams for explaining the controlling of the setting position or the setting range of the visible area. Firstly, with reference to FIG. 6, the explanation is given for a case in which the position for setting the visible area is controlled by adjusting the distance (the clearance gap) between the display element 11 and the aperture controller 12. In FIG. 6, if the display image is shifted to, for example, the right side (in (b) in FIG. 6, see the direction of an arrow R), the light beams move to the left side (in (b) in FIG. 6, see the direction of an arrow L) and thus the visible area moves to the left side (in (b) in FIG. 6, see a visible area B). On the contrary, if the display image is shifted to the left side as compared to (a) in FIG. 6, the visible area moves to the right side (not illustrated).

Moreover, as illustrated in (a) and (c) in FIG. 6, shorter the distance between the display element 11 and the aperture controller 12, closer is the position from the display 10 at which the visible area can be set. Besides, closer the position from the display 10 at which the visible area is set, smaller becomes the light beam intensity. Meanwhile, greater the distance between the display element 11 and the aperture controller 12, farther is the position from the display 10 at which the visible area can be set.

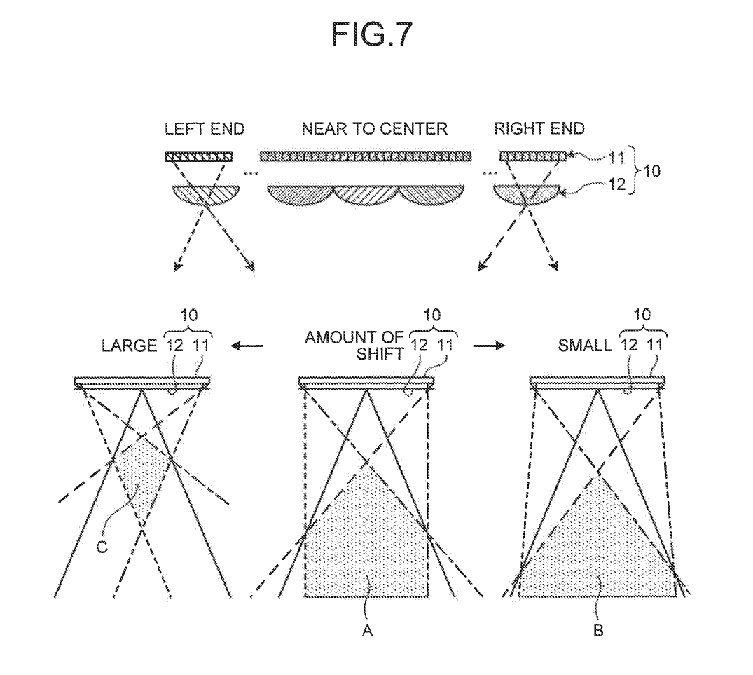

With reference to FIG. 7, the explanation is given for a case in which the position for setting the visible area is controlled by adjusting the arrangement (pitch) of the pixels displayed in the display element 11. Herein, the visible area can be controlled by making use of the fact that the relative misalignment between the positions of pixels and the position of the aperture controller 12 is greater at positions closer to the right end and the left end of the screen of the display element 11. If the amount of misalignment between the positions of pixels and the position of the aperture controller 12 is increased, then the visible area changes from a visible area A illustrated in FIG. 7 to a visible area C illustrated in FIG. 7. On the contrary, if the amount of misalignment between the positions of pixels and the position of the aperture controller 12 is reduced, then the visible area changes from the visible area A to a visible area B illustrated in FIG. 7. Meanwhile, the maximum length of the width of the visible area (i.e., the maximum length in the horizontal direction of the visible area) is called a visible area setting distance.

With reference to FIG. 8, the explanation is given for a case in which the position for setting the visible area is controlled by rotating, deforming, and moving the display 10. As illustrated in (a) in FIG. 8, if the display 10 is rotated, then the visible area A in the basic state can be changed to the visible area B. Moreover, as illustrated in (b) in FIG. 8, if the display 10 is moved, then the visible area A in the basic state can be changed to the visible area C. Furthermore, as illustrated in (c) FIG. 8, if the display 10 is deformed, then the visible area A in the basic state can be changed to a visible area D. In this way, the visible area is fixed according to a combination of the display parameters of the display 10.

In the first embodiment, in a memory (not illustrated) are stored sets of data each of which is associated to visible area information, which contains a combination of display parameters (i.e., information that enables identification of the setting position or the setting range of a candidate visible area), for each of a plurality of candidate visible areas that can be set by the display 10. However, instead of storing the data in the memory, the configuration can be such that, for example, the data is stored in an external device and is obtained by accessing that external device.

Given below is the explanation of the visible area determination method implemented by the determiner 103. Firstly, the explanation is given for a case in which only a single viewer is present. Herein, it is assumed that the first detector 101 outputs the three-dimensional position of only the viewer A. At the point of time when the face of the viewer A is detected, the determiner 103 moves the visible area in such a way that the position of the viewer A is in the center of the visible area. From the subsequent timing, the first detector 101 tracks the viewer A and sequentially inputs the position of the viewer A to the calculator 102.

Then, the calculator calculates the position variation probability P_{A}(t) of the viewer A. In this example, every time the position variation probability P_{A}(t) is calculated, the calculator 102 outputs information indicating the position variation probability P_{A}(t) and the three-dimensional position of the viewer A at that point of time to the determiner 103.

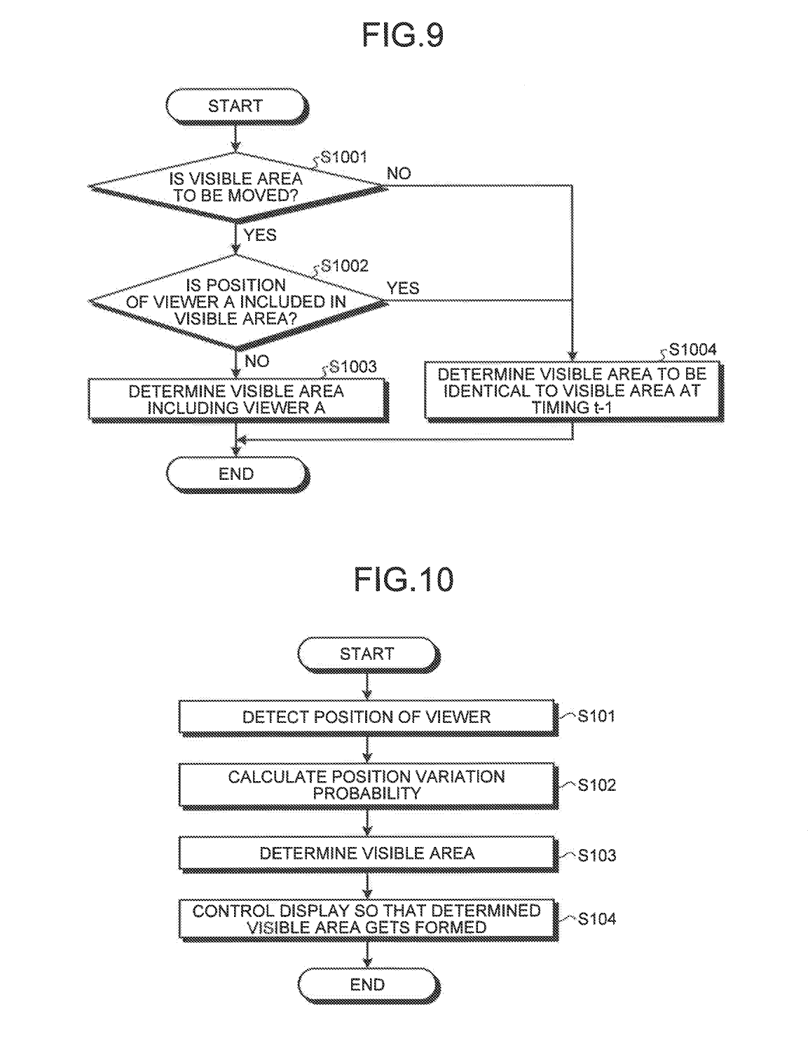

The following explanation is given about the visible area determining method in the case when the position variation probability P_{A}(t) of the viewer A at the timing t is input to the determiner 103. FIG. 9 is a flowchart for explaining an example of operations performed by the determiner 103 in that case. As illustrated in FIG. 9, firstly, based on the position variation probability P_{A}(t), the determiner 103 determines whether or not to move the visible area (i.e., whether or not to change the visible area) (Step S1001). In this example, if the position variation probability P_{A}(t) is equal to or smaller than a threshold value, then the determiner 103 determines to move the visible area. Herein, the threshold value can be set to an arbitrary value, and is set to a value that enables determination of whether or not the viewer has moved. Alternatively, it is also possible to perform hysteretic determination. For example, if the position variation probability of the viewer A is continuously equal to or smaller than a threshold value during a particular time period, then it is determined to move the visible area.

If it is determined not to move the visible area (NO at Step S1001), the determiner 103 determines the visible area at the timing t to be identical to the visible area at the timing t−1 (Step S1004). On the other hand, if it is determined to move the visible area (YES at S1001), then the determiner 103 determines whether or not the position of the viewer A (i.e., the three-dimensional position of the viewer A at the timing t as input from the calculator 102) is included in the visible area determined at the timing t−1 (Step S1002).

If it is determined that the position of the viewer A is included in the visible area determined at the timing t−1 (YES at Step S1002), then the determiner 103 determines the visible area at the timing t to be identical to the visible area at the previous timing t−1 (Step S1004). On the other hand, if it is determined that the position of the viewer A is not included in the visible area determined at the timing t−1 (NO at Step S1002), then the determiner 103 determines the visible area at the timing t in such a way that the position of the viewer A is in the center of the visible area (Step S1003). More particularly, from among a plurality of candidate visible areas stored in the memory (not illustrated), a candidate visible area in which the position of the viewer A is in the center is determined to be the visible area at the timing t by the determiner 103.

Given below is the explanation of a case in which a plurality of viewers is present. For each of the viewers for which the first detector 101 has detected the three-dimensional position, the calculator 102 calculates the position variation probability of that viewer and outputs information indicating the position variation probability P_{A}(t) and the three-dimensional position of the viewer A at that point of time to the determiner 103. Herein, the explanation is given for the visible area determining method in the case in which the position variation probability of each viewer at the timing t is input to the determiner 103. Firstly, based on the position variation probability of each viewer, the determiner 103 determines whether or not to move the visible area.

Herein, any arbitrary method can be implemented to determine whether or not to move the visible area. For example, the determiner 103 can refer to the position variation probabilities of a predetermined number of persons (that can be set in an arbitrary manner) and accordingly determine whether or not to move the visible area. For example, if the position variation probability of any one person is equal to or smaller than a threshold value, then the determiner 103 can determine to move the visible area. Alternatively, if the position variation probabilities of any two persons are equal to or smaller than a threshold value, then the determiner 103 can determine to move the visible area. Still alternatively, for example, from among a plurality of viewers for which the three-dimensional positions are detected, if the position variation probabilities of half of the viewers are equal to or smaller than a threshold value, then the determiner 103 determines to move the visible area. Still alternatively, for example, if the position variation probability of each of a plurality of viewers, for which the three-dimensional positions are detected, is equal to or smaller than a threshold value (i.e., if the position variation probability of all viewers is equal to or smaller than a threshold value); then the determiner 103 determines to move the visible area.

Meanwhile, if it is determined not to move the visible area, then the determiner 103 determines the visible area at the timing t to be identical to the visible area at the timing t−1. On the other hand, if it is determined to move the visible area, then the determiner 103 determines whether or not the position of each viewer is included in the visible area determined at the timing t−1. If it is determined that the position of each viewer is included in the visible area determined at the timing t−1, then the determiner 103 determines the visible area at the timing t to be identical to the visible area at the timing t−1.

On the other hand, if it is determined that the positions of one or more viewers are not included in the visible area determined at the timing t−1; then the determiner 103 determines the visible area at the timing t to such a candidate visible area that, from among a plurality of candidate visible areas stored in the memory (not illustrated), has the largest sum of the position variation probability of each viewer present therein.

Alternatively, for example, the determiner 103 can determine the visible area at the timing t to such a candidate visible area that, from among a plurality of candidate visible areas stored in the memory (not illustrated), has the sum of the position variation probability of each viewer present therein equal to or greater than a predetermined value and has the smallest amount of movement from the visible area at the timing t−1. The reason for that is, if the amount of movement among the visible areas is small, the change occurring in the display image is also small thereby making it possible to reduce the obstruction in the view of the viewers. Still alternatively, for example, the determiner 103 can measure the time (viewing time) for which each viewer views stereoscopic images; and can determine the visible area at the timing t to such a candidate visible area that, from among a plurality of candidate visible areas, has the largest sum total of the product between the viewing time and the position variation probability of each viewer present therein.

Given below is the explanation about the display controller 104 illustrated in FIG. 4. The display controller 104 controls the display 10 in such a way that the visible area determined by the determiner 103 is formed. More particularly, the display controller 104 performs control to set a combination of display parameters included in the visible information that, from among a plurality of sets of visible area information stored in the memory (not illustrated), is associated to the candidate visible area determined by the determiner 103; and performs control to display stereoscopic images on the display 10.

Meanwhile, in the first embodiment, the image processor 30 has the hardware configuration of a commonly-used computer device that includes a central processing unit (CPU), a read only memory (ROM), a random access memory (RAM), and a communication I/F device. The functions of the abovementioned constituent elements (i.e., the first detector 101, the calculator 102, the determiner 103, and the display controller 104) are implemented when the CPU loads computer programs, which are stored in the ROM, in the RAM and runs them. However, that is not the only possible case. Alternatively, at least some of the functions of the constituent elements can be implemented using a dedicated hardware circuit.

FIG. 10 is a flowchart for explaining an example of operations performed by the image processor 30 according to the first embodiment. As illustrated in FIG. 10, the first detector 101 detects the position (the three-dimensional position) of a viewer (Step S101). The calculator 102 calculates a position variation probability based on the temporal change in the position of the viewer (Step S102). Then, based on the position variation probability, the determiner 103 determines a visible area (Step S103). The display controller 104 controls the display 10 in such a way that the determined visible area is formed (Step S104).

As described above, in the first embodiment, based on the temporal change in the position of a viewer, the position variation probability is calculated that indicates the probability of the viewer making a movement. Then, a visible area is determined based on the position variation probability. With that, it becomes possible to perform an appropriate visible area control.

More particularly, the value indicated by the position variation probability decreases as the possibility of the viewer making a movement increases. In the first embodiment, the position variation probability is calculated using a probability distribution in which, the position variation probability becomes greater as the temporal change in the position of the viewer becomes smaller (see Expression (6) given above). Then, if the position variation probability is equal to or smaller than a threshold value, the visible area is moved (changed).

As described in the first embodiment, in the case of detecting the face of a viewer who is appearing in a captured image and accordingly detecting the three-dimensional position of the viewer; as the distance increases from the camera 20 to the viewer, the detection error of the face size increases and the amount of variation increases (v_{A}(t−1)−(v_{A}(t)) in the position of the viewer occurring due to the detection error. Hence, the position variation probability P_{A}(t) that is calculated accordingly becomes smaller (see Expression (6)). For that reason, regardless of the fact that the viewer is motionless in reality, there are times when the position variation probability P_{A}(t) is equal to or smaller than the threshold value, thereby leading to an essentially unnecessary change in the visible area.

In that regard, in the first embodiment, the range of the probability distribution is set in such a way that, as the distance increases from the sensor 20 to the viewer, the probability distribution increases. In this way, by ensuring that, as the distance increases from the sensor 20 to the viewer, the range of the probability distribution increases; even if the amount of variation (v_{A}(t−1)−(v_{A}(t)) in the position of the viewer occurring due to the detection error is large, it becomes possible to prevent a decrease in the position variation probability P_{A}(t) that is calculated accordingly. With that, it becomes possible to achieve the beneficial effect of being able to prevent a change occurring in the visible area due to the detection error (i.e., prevent an essentially unnecessary change in the visible area).

### Second Embodiment

Given below is the explanation of a second embodiment. Herein, the second embodiment differs from the first embodiment in the way that the range of the probability distribution is set to ensure that, as the illuminance lowers which indicates the brightness surrounding the display 10, the range of the probability distribution becomes greater. The details are explained below. Meanwhile, the explanation regarding the contents identical to the first embodiment is not repeated.

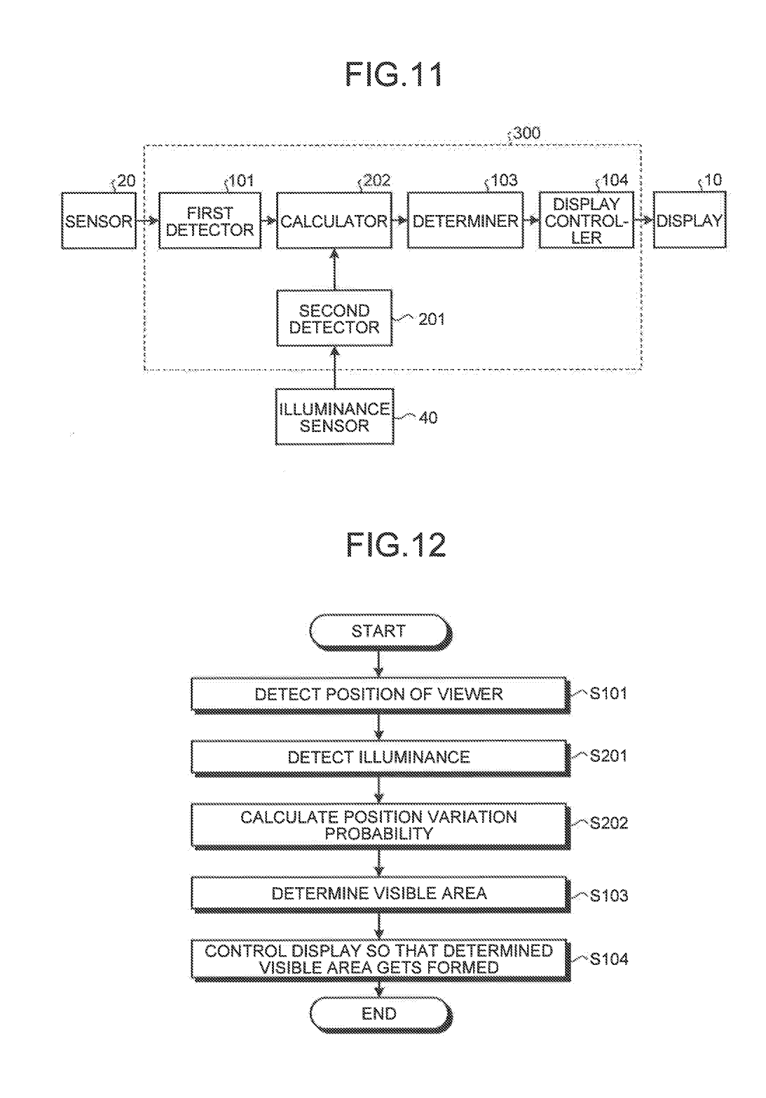

FIG. 11 is a block diagram illustrating an exemplary functional configuration of an image processor 300 according to the second embodiment. As illustrated in FIG. 11, the image processor 300 further includes a second detector 201. In the second embodiment, an illuminance sensor 40 that is used in detecting the brightness surrounding the display 10 is disposed separately from the image processor 30. The illuminance sensor 40 outputs, to the second detector 201, electrical signals corresponding to the brightness (light intensity) surrounding the display 10. Then, based on the electrical signals received from the illuminance sensor 40, the second detector 201 detects the illuminance that indicates the brightness surrounding the display 10, and outputs information indicating the detected illuminance to a calculator 202.

Meanwhile, for example, the second detector 201 can be configured to include the illuminance sensor 40. Alternatively, the configuration can be such that the illuminance sensor 40 is not disposed and the first detector 101 detects the illuminance based on the captured images obtained by the camera 20. That is, the first detector 101 can also have the functions of the second detector 201.

Generally, as the illuminance of the surrounding lowers, the shutter speed decreases so that a visible light sensor of the camera 20 can gather more light. As a result, there occurs an increase in the noise included in the captured images or an increase in the blurring of the captured images. Hence, occurrence of an error in the position of the face to be detected/tracked becomes easier and eventually that error gets reflected in the three-dimensional position of the viewer. Moreover, in the case when the position variation probability, which is calculated according to the amount of variation occurring in the position of the viewer due to that detection error (i.e., according to the temporal change in the position of the viewer), is equal to or smaller than a threshold value; it leads to an essentially unnecessary change in the visible area.

In that regard, in the second embodiment, the calculator 202 sets the probability distribution in such a way that, as the illuminance lowers that is detected by the second detector 201, the range of the probability distribution becomes greater. If the range of the probability distribution is widened in inverse proportion to the illuminance; then, for example, even if it is likely to have a detection error in the position of the viewer due to the lowness in the brightness surrounding the display 10, it becomes possible to prevent a situation in which the position variation probability that is calculated according to the amount of variation occurring in the position of the viewer due to that detection error decreases to be equal to or smaller than a threshold value. For example, as illustrated in Expression (12) given below, the calculator 202 can do the setting in such a way that, as the illuminance lowers that is detected by the second detector 201, the values of σx, σy, and σz become greater. In Expression (12), σ(l) represents a coefficient that increases in inverse proportion to the illuminance. Thus, as the illuminance lowers, the coefficient σ(l) becomes greater.

σₓ←α(l)σₓ, σ_{y}←α(l)σ_{y}, σ_{z}←α(l)σ_{z} (12)

In the second embodiment too, in an identical manner to the first embodiment, the image processor 300 has the hardware configuration of a commonly-used computer device that includes a CPU, a ROM, a RAM, and a communication I/F device. The functions of the abovementioned constituent elements (i.e., the first detector 101, the second detector 201, the calculator 202, the determiner 103, and the display controller 104) are implemented when the CPU loads computer programs, which are stored in the ROM, in the RAM and runs them. However, that is not the only possible case. Alternatively, at least some of the functions of the constituent elements can be implemented using a dedicated hardware circuit.

FIG. 12 is a flowchart for explaining an example of operations performed in the image processor 300 according to the second embodiment. As illustrated in FIG. 12, the first detector 101 detects the position (the three-dimensional position) of a viewer (Step S101). The second detector 201 detects the illuminance (Step S201). The calculator 202 sets the probability distribution according to the illuminance detected at Step S201. Then, the calculator 202 refers to the probability distribution that is set and calculates a position variation probability based on the temporal change in the position of the viewer (Step S202). Subsequently, based on the position variation probability, the determiner 103 determines a visible area (Step S103). The display controller 104 controls the display 10 in such a way that the determined visible area is formed (Step S104).

Meanwhile, the computer programs executed in the image processors (the image processor 30 and the image processor 300) can be saved as downloadable files on a computer connected to the Internet or can be made available for distribution through a network such as the Internet. Alternatively, the computer programs executed in the image processors (the image processor 30 and the image processor 300) may be stored in advance in a nonvolatile storage medium such as a ROM, and provided as a computer program product.

While certain embodiments have been described, these embodiments have been presented by way of example only, and are not intended to limit the scope of the inventions. indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device, comprising:
a first detector configured to detect a position of a viewer;
a calculator configured to calculate a position variation probability that indicates a probability of the viewer making a movement, based on positions detected at different times; and
a determiner configured to determine a visible area within which stereoscopic images to be displayed on a display are visible, based on the position variation probability.

2. The device according to claim 1, wherein
a value indicated by the position variation probability decreases as the possibility of the viewer making a movement increases, and
the determiner is configured to change the visible area when the position variation probability is equal to or smaller than a threshold value.

3. The device according to claim 2, wherein the calculator is configured to calculate the position variation probability using a probability distribution that indicates that the position variation probability becomes greater as a temporal change in the position of the viewer becomes smaller.

4. The device according to claim 3, wherein the calculator is configured to calculate the probability distribution such that the range of the probability distribution increases as the distance increases from a sensor used in detecting the position of the viewer to the viewer.

5. The device according to claim 3, further comprising a second detector configured to detect an illuminance that indicates brightness surrounding the display, wherein
the calculator is configured to set the probability distribution such that a range of the probability distribution becomes greater as the illuminance lowers.

6. The device according to claim 3, wherein
the determiner is configured to determine the visible area such that the position of the viewer is included in the visible area when the viewer is one in number and when it is determined to change the visible area, and
the determiner is configured to determine the visible area such that a sum of the position variation probability of each of the viewer present within the visible area is the largest when the viewer is more than one in number and when it is determined to change the visible area.

7. The device according to claim 1, wherein the calculator is configured to calculate the current position variation probability using the position variation probability calculated based on the positions detected during a predetermined time period in the past.

8. The device according to claim 7, wherein the predetermined time period is expressed as the product of a detection interval that indicates an interval at which the first detector performs detection and an integer that is set to a value that increases as the detection interval decreases.

9. The device according to claim 1, further comprising a display controller configured to control the display in such that the visible area determined by the determiner is formed.

10. An image processing method comprising:
detecting a position of a viewer;
calculating a position variation probability that indicates a probability of the viewer making a movement, based on positions detected at different times; and
determining a visible area within which stereoscopic images to be displayed on a display are visible, based on the position variation probability.

11. A stereoscopic image display device comprising:
a display configured to display a stereoscopic image;
a first detector configured to detect a position of a viewer;
a calculator configured to calculate a position variation probability that indicates a probability of the viewer making a movement, based on positions detected at different times; and
a determiner configured to determine a visible area within which stereoscopic images to be displayed on the display are visible, based on the position variation probability.

12. The device according to claim 11, wherein
a value indicated by the position variation probability decreases as the possibility of the viewer making a movement increases, and
the determiner is configured to change the visible area when the position variation probability is equal to or smaller than a threshold value.

13. The device according to claim 12, wherein the calculator is configured to calculate the position variation probability using a probability distribution that indicates that the position variation probability becomes greater as a temporal change in the position of the viewer becomes smaller.

14. The device according to claim 13, wherein the calculator is configured to calculate the probability distribution such that the range of the probability distribution increases as the distance increases from a sensor used in detecting the position of the viewer to the viewer.

15. The device according to claim 13, further comprising a second detector configured to detect an illuminance that indicates brightness surrounding the display, wherein
the calculator is configured to set the probability distribution such that a range of the probability distribution becomes greater as the illuminance lowers.

16. The device according to claim 13, wherein
the determiner is configured to determine the visible area such that the position of the viewer is included in the visible area when the viewer is one in number and when it is determined to change the visible area, and
the determiner is configured to determine the visible area such that a sum of the position variation probability of each of the viewer present within the visible area is the largest when the viewer is more than one in number and when it is determined to change the visible area.

17. The device according to claim 11, wherein the calculator is configured to calculate the current position variation probability using the position variation probability calculated based on the positions detected during a predetermined time period in the past.

18. The device according to claim 17, wherein the predetermined time period is expressed as the product of a detection interval that indicates an interval at which the first detector performs detection and an integer that is set to a value that increases as the detection interval decreases.

19. The device according to claim 11, further comprising a display controller configured to control the display in such that the visible area determined by the determiner is formed.
